(19) United States
(12) Patent Application Publication
(10) Pub. No.: US 2026/0243567 A1
(43) Pub. Date: Aug. 20, 2026

(54) ACOUSTIC TELESCOPE SYSTEM AND METHOD OF USING SAME

(71) Applicant: WOODS HOLE OCEANOGRAPHIC INSTITUTION, Wood hole, MA (US)

(72) Inventors: Ying Tsong LIN, Woods Hole, MA (US); John KEMP, Woods Hole, MA (US); Donald PETERS, Woods Hole, MA (US)

(73) Assignee: WOODS HOLE OCEANOGRAPHIC INSTITUTION, Woods Hole, MA (US)

(21) Appl. No.: 19/108,230

(22) PCT Filed: Sep. 1, 2023
(86) PCT No.: PCT/US2023/031866

§ 371 Date: Mar. 3, 2025

Related U.S. Application Data
(60) Provisional application No. 63/403,431, filed on Sep. 2, 2022.

(51) Int. Cl. G01C 13/00; B63B 22/00; B63B 22/04; G01S 3/801; G01V 1/18

(52) U.S. Cl. CPC G01C 13/008; B63B 22/04; G01S 3/801; G01V 1/186; B63B 2022/006; B63B 2211/02

(57) ABSTRACT

Disclosed herein are acoustic telescope system that include a hydrophone array, a surface buoy, a GPS tracker, a long baseline navigation system, a central processing unit, a data acquisition system, an electrical power architecture, a housing, an electromagnetic stretch hose, a subsurface bouy, an armored electromechanical cable, a hairy fairing, a mooring chain, a mooring controller, a swivel, an anchor, an acoustic release transponder, a receiver, a transmitter, an electronic component, a software component, a transceiver, a transducer, a detector, a mooring, and an antennae. Also, disclosed are methods of using the acoustic telescope system that can include: recognizing with a passive acoustic localization, wherein the passive acoustic localization recovers a signal distortion after traveling through the ocean environment; sampling acoustic pulses received on an hydrophone with separate arrival times; and localizing sound sources with acoustics signal back-propagation to reconstruct a source signature.

### CROSS-REFERENCE TO RELATED APPLICATIONS

This application claims benefit of priority under 35 U.S.C. § 119(e) of U.S. Ser. No. 63/403,431, filed Sep. 2, 2022, the entire contents of which is incorporated herein by reference in its entirety.

### BACKGROUND

### Field

The field of the invention is underwater acoustics.

### Description of the Related Art

The ocean is a defining feature of planet Earth, covering 70 percent of its surface and crucial to life on it. Still, the ocean remains one of the last unexplored frontiers, as continuous sensing and probing of every corner of the ocean is a logistic and financial challenge, if not unrealistic. Considering the coverage of the ocean and its depth, which is 3,680 m on average and much greater than the average elevation on land of 840 m, remote sensing represents a superior approach to elucidating the extensive unexplored ocean's interior. However, many propagating energy forms (light, radio waves) decay rapidly underwater with distance, limiting the use of remote sensing—except for sound waves. Sound can be used to explore the ocean's opaque interior, and many oceanographic advances have been made possible with underwater acoustic technologies.

Environment recognition using acoustic features (soundscape recognition) is an important topic in passive acoustic monitoring of the ocean environment. In a biological context, this technology has widely been used to describe habitat (Haver et al., 2018; Heenehan et al., 2017), assess marine mammal abundance and distribution (Marques et al., 2013; Martin et al., 2013; Küsel et al., 2011; Davis et al., 2017), study fish distribution patterns (Vester et al., 2004; Urazghildiiev and Van Parijs, 2016), marine invertebrate behavior (Versluis et al., 2000), coral reefs (Kaplan et al., 2013; Mooney et al., 2017), fish depredation (Thode et al., 2015) and generate baseline data on the ocean acoustic environment around the globe (Haver et al., 2017; Menze et al., 2017). An example of a marine biology observatory network is the Northeast Passive Acoustic Sensing Network (NEPAN) hosted by the National Oceanic and Atmospheric Administration (NOAA) for the study of marine mammal and cod fish ecology along the Northeast US Coast.

In geosciences, passive acoustic monitoring has been broadly used to infer geophysical and meteorological sound sources and their impacts on the acoustic environment. This includes offshore and remote meteorological data analysis (Collins, 2011), tides (Bazile Kinda and Bonnel, 2015), glacier calving (Glowacki et al., 2015) and cryoseismic events, earthquake detection (Northrop, 1962), iceberg tremors (Müller et al., 2005) and underwater volcanic activities (Snodgrass and Richards, 1956; Matsumoto et al., 2011). An example of a geosciences observatory network is the North East Pacific Time-series Undersea Networked Experiments (NEPTUNE) in Canada, which has both passive and active acoustic nodes.

Real-time passive acoustic monitoring using low data speed Iridium satellite communication has been implemented in the last decade. However, existing Iridium enabled hydrophone networks can only transmit back to shore the results of mission-specified onboard signal detection, not the complete acoustic signals for multi-task purposes. Examples include the Cape Cod Right Whale Listening Network for preventing ship-strikes to whales, which uses hydrophone buoys to detect and classify Northern Atlantic right whale calls and transmits possible true positive detections. This mission specified onboard detection approach has also been extended for mobile platforms in recent years (Baumgartner et al., 2013), but still only certain detection data is transmitted back to shore, limiting the application of such mobile passive acoustic monitoring platforms.

Another common problem of passive acoustic monitoring systems is the storage, stowage, and transportation of ocean-going systems. Large structures can take up considerable vessel deck space. A desirable solution would have a collapsible structure that presents a smaller footprint during transportation, and is articulated open when needed, preferably after deployment into the ocean.

Consequently, there is need for new acoustic telescopes that can be used for passive acoustic monitoring and can have collapsible structures.

### SUMMARY

Provided herein is an acoustic telescope system. In one embodiment, the system performs passive acoustic monitoring. In one or more embodiments, the system comprises collapsible structures for mobility.

In one or more embodiments, the acoustic telescope system comprises: a hydrophone (sometimes referred to herein as an acoustic telescope), a surface buoy, a GPS tracker, a long baseline navigation system, a central processing unit, a data acquisition system, an electrical power architecture, a housing, an electromagnetic stretch hose, a subsurface bouy, an armored electromechanical cable, a hairy fairing, a mooring chain, a mooring controller, a swivel, an anchor, an acoustic release transponder, a receiver, a transmitter, an electronic component, a software component, a transceiver, a transducer, a detector, a mooring, and an antennae.

In one or more embodiments, a method of using the acoustic telescope system comprises: recognizing with a passive acoustic localization, wherein the passive acoustic localization recovers a signal distortion after traveling through the ocean environment; sampling acoustic pulses received on an hydrophone with separate arrival times; and localizing sound sources with acoustics signal back-propagation to reconstruct a source signature.

### BRIEF DESCRIPTION OF THE DRAWINGS

The present disclosure can be better understood by referring to the following drawings. The drawings constitute a part of this specification and include exemplary embodiments of the acoustic telescope, which can be embodied in various forms.

FIG. 1 shows an embodiment of the acoustic telescope in accord with the present invention with the arm assemblies in the open position.

FIG. 2 shows an embodiment of an acoustic telescope in accord with the present invention with the arm assemblies closed.

FIG. 3 shows an side view of an embodiment of an acoustic telescope in accord with the present invention with the arm assemblies closed.

FIG. 4 shows a detailed view of the top of an embodiment of the acoustic telescope showing its cable connection.

FIG. 5 shows a detailed view of the bottom of an embodiment of the acoustic telescope showing its connection cable.

FIG. 6 shows a detailed view of the cable connections of the acoustic telescope.

FIG. 7 shows a cross-section schematic of the top half of the acoustic telescope array showing the acoustic components.

FIG. 8 shows a skeletal view of an embodiment of the acoustic telescope array body with one arm assembly which is in the open or extended configuration, which depicts the main weldment.

FIG. 9A shows the top half of one embodiment of the acoustic telescope system.

FIG. 9B shows the top half of one embodiment of the acoustic telescope system.

FIG. 10 shows another embodiment of the acoustic telescope system with horizontal projects of the acoustic beans at different frequencies and a depiction of the spatial placement of hydrophones along the acoustic telescope arm assemblies in one embodiment.

FIG. 11 shows the date compression flow for the real-time telemetry.

FIG. 12 shows another embodiment of the acoustic telescope system where the acoustic telescope is a tetrahedral hydrophone volumetric array with a vector sensor.

FIG. 13A shows an acoustic telescope perspective view where acoustic telescope is a tetrahedral hydrophone volumetric array.

FIG. 13B shows a second view of an acoustic telescope perspective view where acoustic telescope is a tetrahedral hydrophone volumetric array.

FIG. 14 shows the electronic system of the acoustic telescope system.

FIG. 15 shows the array breakout electronic system.

### DETAILED DESCRIPTION

Disclosed herein is an acoustic telescope system comprising: one or more hydrophone arrays or acoustic telescopes, one or more surface buoys, one or more GPS trackers, one or more long baseline navigation system, one or more central processing units, one or more data acquisition systems, one or more electrical power architectures, one or more housings, one or more electromagnetic stretch hoses, one or more subsurface bouys, one or more armored electromechanical cables, one or more hairy fairings, one or more mooring chains, one or more mooring controllers, one or more swivel, one or more anchors, one or more acoustic release transponder, one or more receivers, one or more transmitters, one or more electronic components, one or more software components, one or more transceivers, one or more transducers, one or more detectors, one or more moorings, and one or more antennae.

In one or more embodiments, the acoustic telescope system can include, but are not limited to: six phased hydrophone arrays configured for electronic steering and focusing of acoustic beams and equipped with a satellite communication system for real-time data transmission. The acoustic telescope apparatus can enable a variety of remote deep-water explorations by listening to ambient sound generated by biological, geophysical, and meteorological events, as well as oceanographic and anthropogenic processes and activities. The acoustic telescope system can provide a more complete, even holistic understanding of oceanic environmental processes by integrating underwater soundscape parameters with other oceanographic and meteorological measurements. The acoustic telescope system can image diversified soundscape observations (basin scale ocean acoustic holography), inference of marine life environments and interactions (soundscape ecology), and remote acoustic sensing of oceanographic, geological, and seismological processes. The acoustic telescope system can gather acoustic data, supply information processing for high-volume and high-speed data telemetry, yield acoustic feature recognition, and mooring for minimal mechanical vibration noise. The acoustic telescope system can be deployed and suspended in the middle of the water column at the edge of the shelf break for the best listening coverage into the deep ocean basin. The shelf break currents are expected to be high and variable, so the mooring engineering can provide minimal mechanical vibration noise on the acoustic array.

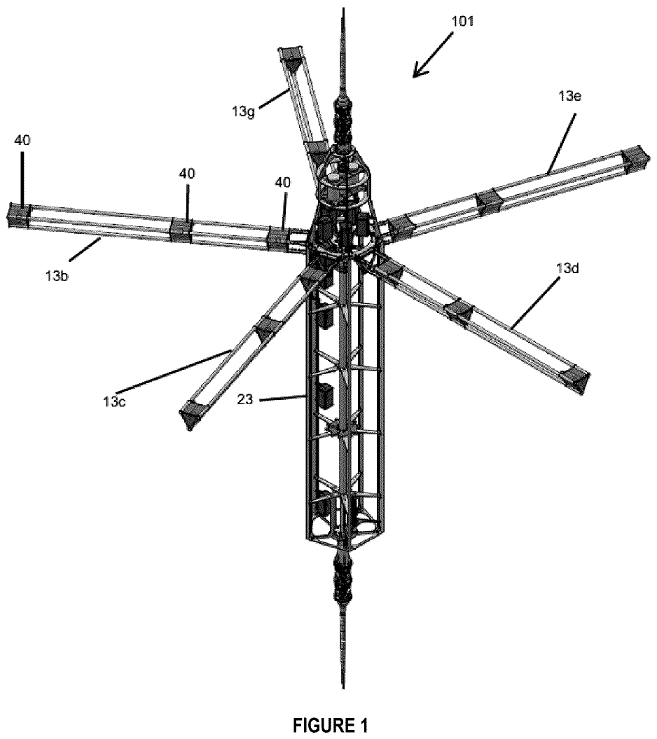

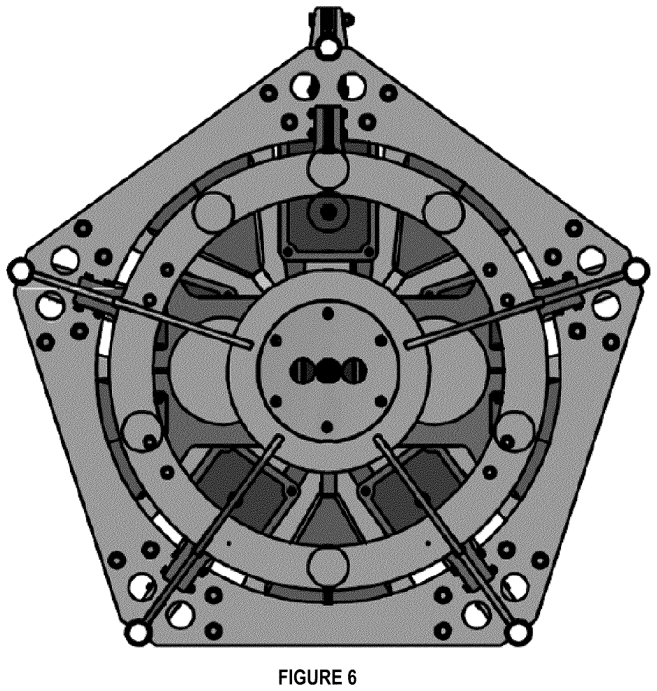

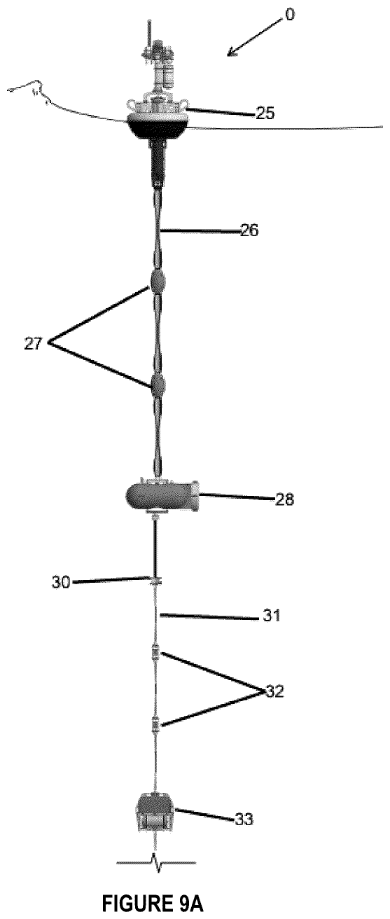

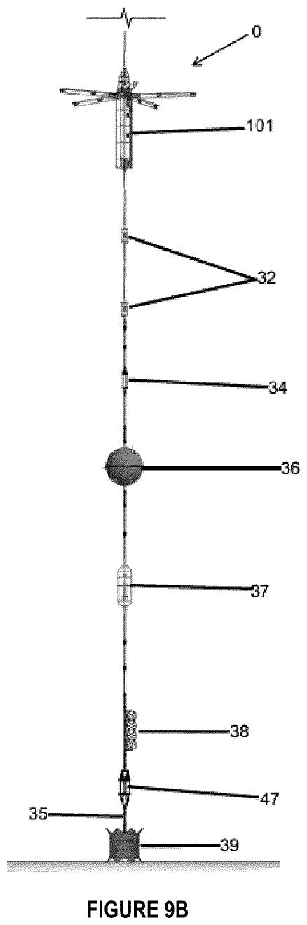

FIGS. 9A, 9B, 10, and 12 show embodiments of the acoustic telescope system and FIGS. 1-8 and 13A, 13B show embodiments of the acoustic telescope 101 used with the acoustic telescope system. In one or more embodiments, the acoustic telescope 101 provides real-time, three-dimensional data of the underwater embodiment.

In one embodiment, the acoustic telescope system comprises phased hydrophone arrays and real-time high volume data compression and telemetry from a remote and harsh oceanic environment. Like optical and radio wave telescopes, the 3D acoustic telescope system can include beam steering and focusing by electronically adjusting the phased arrays to localize sound sources. The acoustic telescope system can steer and focus its listening beams to localize different sound sources simultaneously.

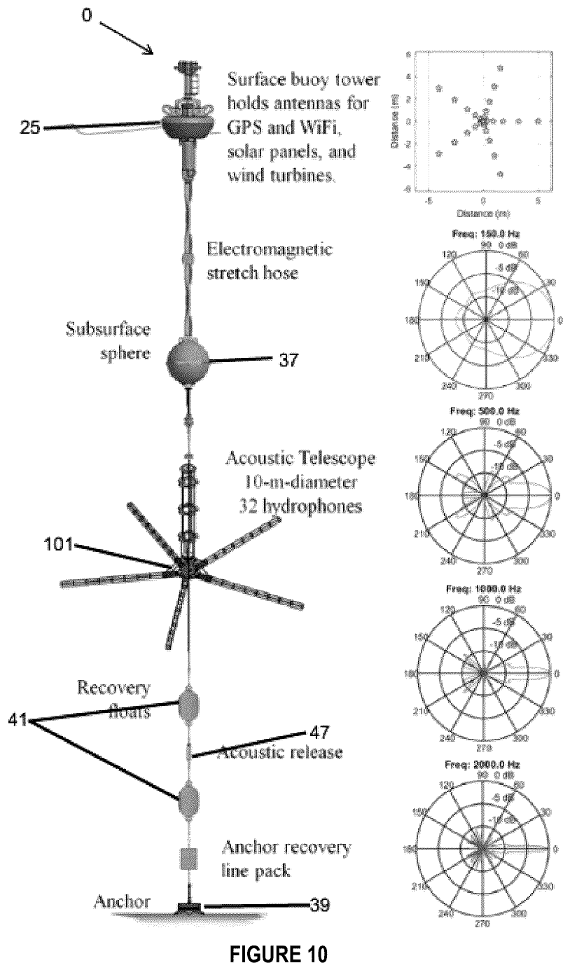

Turning to the system shown in FIGS. 9A, 9B, 10, and 12, simplified embodiments of acoustic telephone system is depicted for illustrative purposes. As shown in FIG. 10, the system 0 may comprise a surface buoy 25, a subsurface sphere 37, an acoustic telescope 101, one or more backup recovery buoyancy 41, and an anchor 39, wherein the components are positioned substantially vertically in a water column and connected to each other through a series of cables and/or conduits, including electromagnetic strength hose. In addition to the hydrophones located on the acoustic telescope 101, the system 0 may also comprise hydrophone cages with flow shiels 32. A power package 33 may also be included. Additionally, one or more releases 47 may be incorporated at determined intervals.

In one or more embodiments, the acoustic telescope system may use a three-dimensional hydrophone array that holds a multiplicity of hydrophones at fixed locations in space relative to one another, located within the water column of a body of water, at known position and orientation in world coordinates. The apparatus may use electronic systems to sense, record, store, process, and transmit acoustic signals received by a multiplicity of spatially separated hydrophones. The apparatus may use electronic systems to sense, measure, record, store, process, and transmit three-dimensional position information of the array coincident with acoustic measurements. The apparatus may use clock(s) with sufficient precision to determine the arrival time of acoustic signals detected by all hydrophones in the array. The apparatus may georeference the hydrophone array local coordinate system (mooring axis, and the plane perpendicular to the mooring axis) to the global vertical axis and global horizontal plane using the measured three-dimensional position information measured during acoustic sensing. The apparatus may use beamforming on signals received by a multiplicity of spatially separated hydrophones to resolve bearing and azimuth of sensed acoustic sources. The apparatus may use a mooring or other structure to locate the hydrophone array within the water column of a body of water. The apparatus may store, condition, and transmit electrical energy to electronic array and mooring systems and components that require power.

The acoustic telescope system can transmit, process, analyze and visualize the high volume, high velocity (speed of data in and out) and high diversity of acoustic data. The one or more software components of the acoustic telescope system can include acoustic data compression algorithms. The acoustic telescope can compress, communicate/telemeter, quantify and infer ocean environmental information embedded in the soundscape measurements.

The acoustic telescope system can include real-time, high-speed, and high-volume acoustic data telemetry by a satellite internet link. This data telemetry capability provided by the acoustic telescope system on acoustic networks can performed using fiber or electromechanical cable connections. The acoustic telescope system can be used in conjunction with current systems, such as the U.S. Navy's Sound Surveillance System (SOSUS), Comprehensive Test Ban Treaty organization (CTBTO), NEPTUNE Canada, U.S. Navy test ranges in the Bahamas (Atlantic Undersea Test and Evaluation Center, AUTEC), and other places.

The acoustic telescope system can have a broad acoustic frequency bandwidth for listening to different sound types. For example, ambient sound in the ocean has two general catalogs: natural and anthropogenic, and Bradley and Stern (2008) have augmented the classic Wenz curve (Wenz, 1962) to provide a complete diagram showing the frequency coverage and spectrum level of different noise sources in the ocean from 1 Hz to 100 kHz. In short, natural sources include animals, earthquakes, volcano eruptions, rainfall, wind, waves, etc. Anthropogenic sources due to human activities include different types of sonar systems, noise related to engines, thrusters and other equipment on ships or marine platforms. The impacts of anthropogenic noise on the environment encompass its own research field (Nowacek et al., 2007; Merrill, 2003; Council, 2005). Impacts might be generated through naval sound sources (Halvorsen et al., 2012), ship traffic (Gervaise et al., 2012), seismic (scientific and resource exploration) activities as well as renewable energy construction (Halvorsen et al., 2012; Dähne et al., 2013) and operation (Scheidat et al., 2011; Tougaard, 2015). Therefore, passive acoustic monitoring became a standard tool to assess impacts as it provides an easy means for long-term monitoring of the sound in a selected area (Van Parijs et al., 2009; Booth et al., 2017).

Turning to FIGS. 9A and 9B, an alternative embodiment of an acoustic telephone system 0 is provided comprising: one or more surface buoys 25, one or more conductor cables with or without hairy fairing 31, one or more subsurface buoys or floats 28, one or more conductor stretch hoses, 26, one or more host interface buoys (HIBs) 27 one or more adapter housings 30 to connect cables and/or hoses, one or more power packages 33, one or more acoustic telescopes 101, one or more hydrophone cages with a flow shield 32, one or more releasers 34, one or more mooring chains 35, one or more syntactic foam spheres 36, one or more long baseline transducers 37 and corresponding cages (preferably with the transducer pointed upwards towards the surface), one or more glass balls on trawler chains 38, and one or more anchors 39, which is depicted as a mace anchor. At least one or more of the conduits or cables may further comprise Hairy Fairing.

An anchor 39 secures the system while deployed and is attached to further instrumentation with a mooring chain, for instance a five-meter ½ inch chain. Multiple releases may be placed throughout the system 0 to effectuate deployment and subsequent recover. Those releases may be a duel release with ½ inch dualling chain. In one embodiment, there is a main mooring acoustic release (COTS).

The one or more housings can include an electronic housing. The electronic housing can include one or more batteries, one or more analogue-digital converter, one or more system bases chips, one or more chip scale atomic clocks, and one or more hydrophone four wire inputs.

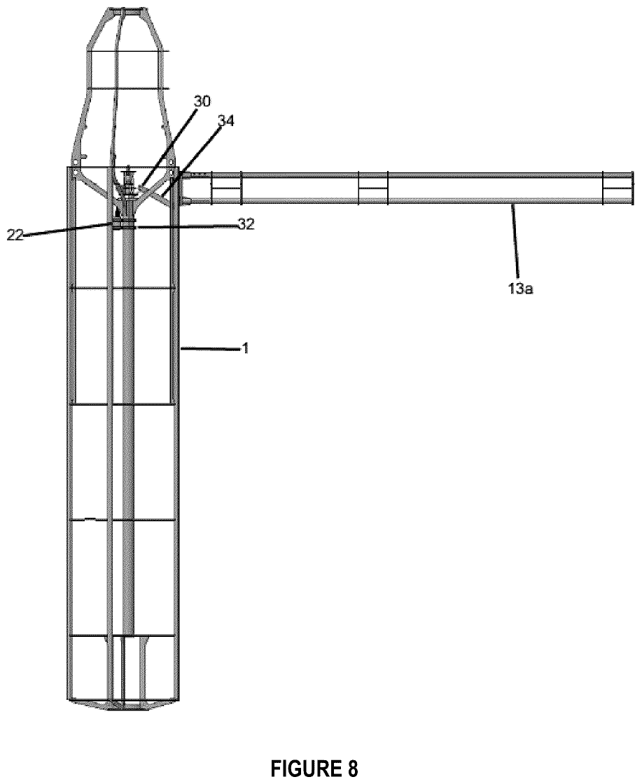

A long baseline (LBL) position system may be used in the system to effectuate subsea positioning. As shown in FIG. 8, an LBL transducer is located near the anchor. A foam or other buoyant material sphere 36 may be used to increase buoyance along the system 0 at lower depths. For example, a syntactic foam sphere approximately 62 inches in diameter may be used. The system may include a power assembly or cube 33. For example, one or more PowerCUBEs (batteries for system power in a neutrally-buoyant assembly) or other power source may be used.

The system further comprises mechanical elements (chain, wire rope), electromechanical (EM) cable segments with hairy fairing to mitigate cable strum, one or more EM terminations to provide electrical and mechanical tension and bending interfaces for each end of each EM cable segment, one or more EM chain element (robust interface at top of the EM cable portion of the mooring), a subsurface buoy (buoyancy element to support mooring weight and maintain mooring tension), EM mooring stretch hose (elastic electromechanical element to absorb wave motions and reduce peak dynamic loads from surface buoy), and a Surface buoy (supporting communication between the array and nearby vessel(s) via line-of-sight radio, and shore via satellite telemetry).

One or more inline hydrophone cages with hydrophones 32 contained in shields to mitigate flow noise and interfaces to EM terminations may be included in the system in addition to an acoustic telescope 101. As shown, in FIG. 9A, one or more EM cable segments and inline hydrophone cages 32 are located above the array 101. The one or more buoys 27 can include, but are not limited to: one or more solar panels, one or more wind turbines, one or more batteries, one or more single board computers, one or more digital subscriber line modems, and one or more Wi-Fi transceivers.

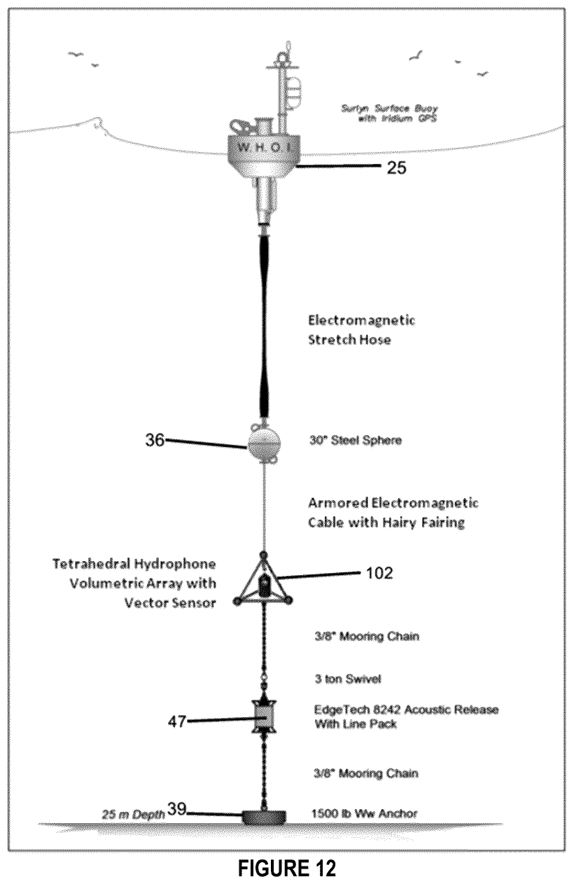

Regarding FIG. 12, an alternate embodiment of an acoustic telephone system is provided wherein the acoustic telescope is replaced with one or more tetrahedral hydrophones 102.

Turning now to the acoustic telescope 101. The acoustic telescope 101 is equipped with a plurality of underwater devices to detect and record ocean sounds from all directions. In the preferred embodiments, between 6 and 25 hydrophones are placed on the acoustic telescope 101 at varying intervals. FIG. 10 depicts one embodiment of the spacing of the hydrophones across the arm assemblies of the acoustic telescope 101. As depicted, the hydrophones are more spaced out along the length of the arm assemblies. Using multiple hydrophones simultaneously creates one system capable of measuring and distinguishing imaging soundscapes, monitoring inference of marine life environment and interactions, and remote acoustic sensing of oceanographic, geological, and seismological processes. Any suitable hydrophone as known in the art may be used. By using an array of hydrophones, the acoustic telescope system provides an integrated acoustic view of the ocean by vastly increasing the breadth of data obtained by a single instrument and by resolving each sound source's 3D position rather than only detecting its presence.

The acoustic telescope system can be deployed alone or in a series of other arrays, including other acoustic telescopes/telescope system.

The one or more sensors can include, but are not limited to: a motion pack sensor, tilt sensor, acoustic vector sensor, gyroscope, heading, accelerometers, temperature sensor, salinity sensor, pressure sensor, and a depth sensor.

The acoustic telescope system can include an electromagnetic stretch hose 26. The electromagnetic stretch hose 26 can keep the acoustic telescope system stable and to reduce the mooring vibration caused by wind, waves and currents acting on the surface buoy.

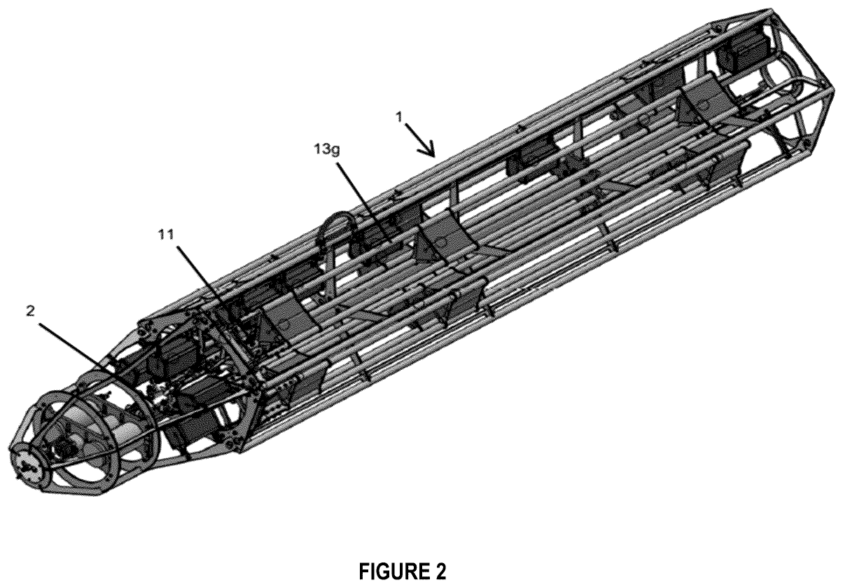

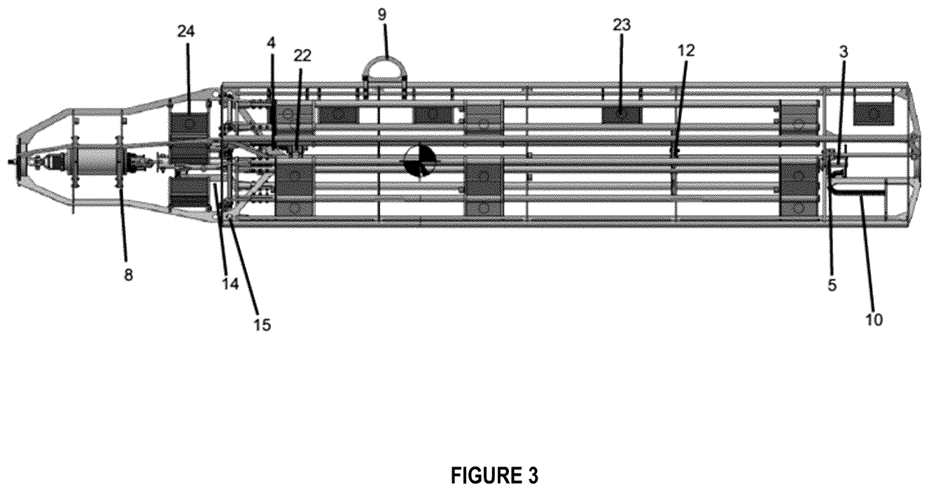

The acoustic telescope is collapsible under its own mechanical load. FIGS. 2 and 3 show the assembly arms of the telescope collapsed. FIG. 1 shows the acoustic telescope 101 with five arm assemblies 13a-e in a open position. The hydrophones are shown, for instance, at 40 along the arm assemblies 13a-e.

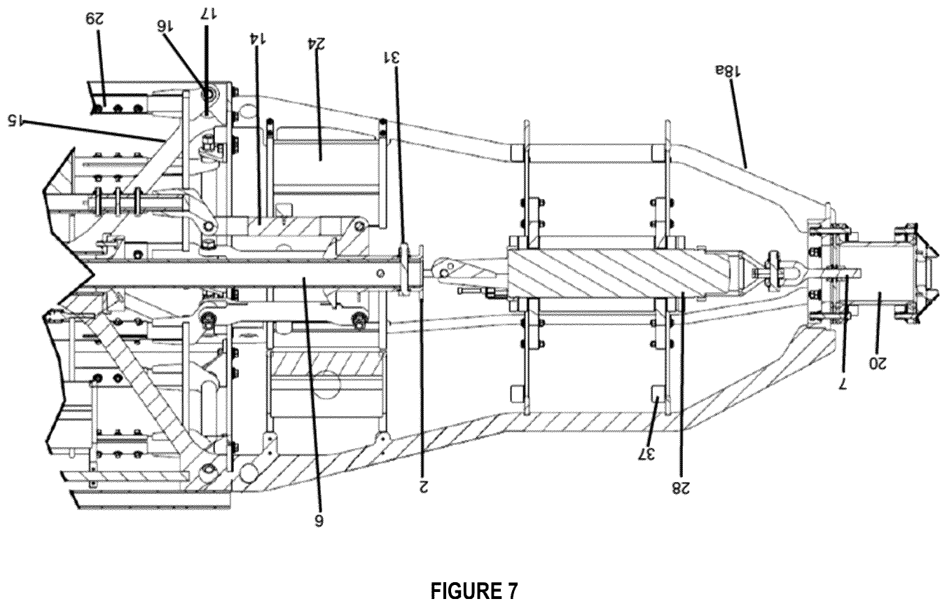

Turning to FIGS. 2 and 3, an illustrative embodiment of the acoustic telescope is depicted with the arm assemblies 13a-e in the collapsed or closed position. As depicted the acoustic telescope 101 may include one or more weldments, including a main weldment 1, which may act as an exoskeleton for the array and may define an envelope, an actuator, one or more arms (or arm assemblies), and one or more acoustic devises such as a hydrophone located on said one or more arm assemblies. The actuator may be capable of moving said one or more arms from a collapsed position to a deployed position. The actuator mechanism may include an actuator tube with two ends, with a head weldment 2 on one end (the “top end” in relation to the configuration when deployed) and an actuator tube weldment 3 on the distal end. An actuator stop cone 4 may be positioned distal to the actuator head weldment to act as a stop in the actuation to prevent movement beyond a specified point. FIG. 7 shows simplified view but removes the majority of the components to provide a better perspective view of the main weldment, the actuator and its components, and one arm in the deployed position.

As shown in FIGS. 2-5, the acoustic telescope may include one or more of the following: Main Weldment 1, Actuator Head Weldment 2, Actuator Tube Weldment 3, Actuator Stop Cone 4, Actuator Lower Bushing 5, Actuator rod 6, Release Hanger Assembly 7, Housing Saddle Assembly 8, Lift Bale Assembly 9, Cable Manager Assembly 10, Position Switch Assembly 11, Arm Rest Stop Assembly 12, Arm Assembly 13, Arm Drive Link 14, Arm Pivot Shaft 15, Interface, Upper Term 20, Interface, Lower Term 21, Motion Pack Assembly 22, Lower Phone Cage Assembly 23, and Upper Phone Cage Assembly 24.

In at least one embodiment, the apparatus comprises a plurality of movable arm assemblies 13a-e that are connected to the main weldment 1 at their inner ends, and fold down to be stowed within the main weldment 1 envelope to assist with handling on and from a surface vessel for the purposes of mooring deployment and recovery. The arms 13a-e may be connected either directly or indirectly via linkage to a central tension member (the actuator rod 19) within the apparatus. The acoustic telescope may include an umbrella-like mechanism to open and close the array apparatus for deployment and recovery. In one or more embodiments, the mechanism for opening (deploying) the arm assemblies 13a-e and closing them may be passive, active, or a combination thereof. In at least one embodiment, a motor may be employed to act upon said tension member.

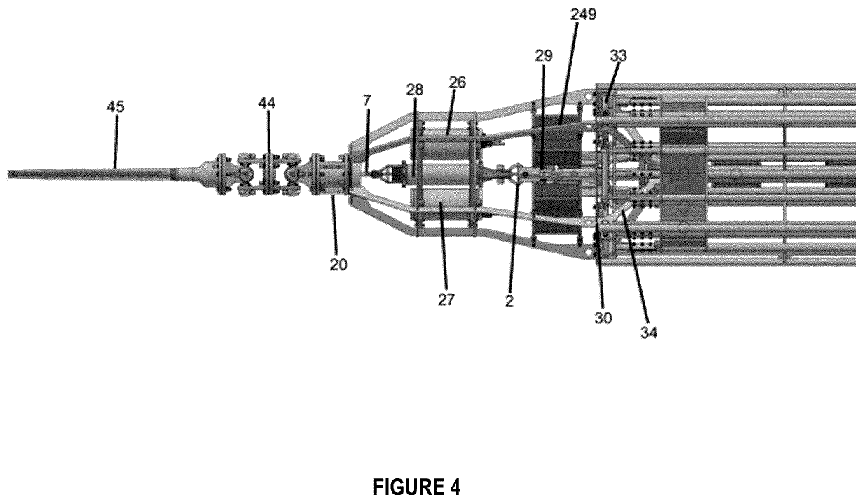

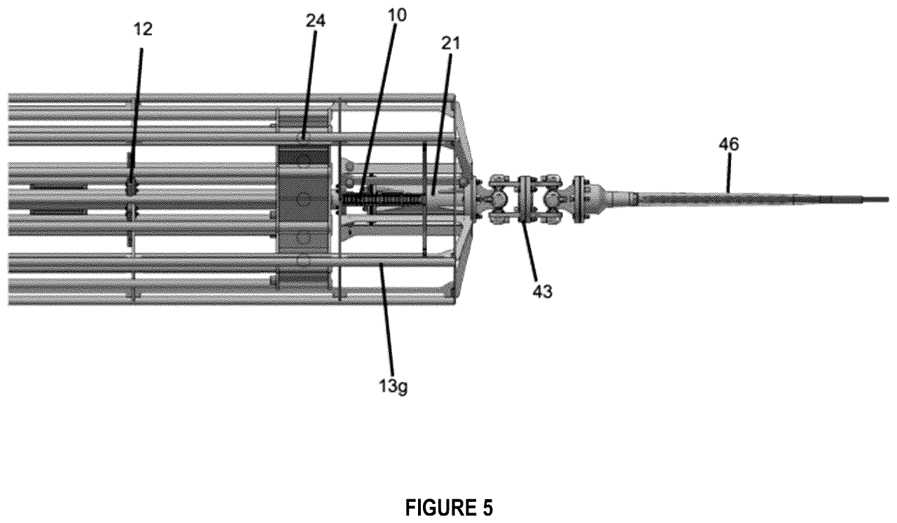

In other embodiments, the tension member may be acted upon by tension contributed to by gravity. For example, the moveable tension member (actuator rod 6) may be connected to the cable 46 below (FIG. 5). This may be via the interface 43 (FIG. 5). The top of the main frame weldment 1 may be connected to the mooring EM cable 45 (FIG. 4) above via interface 44 (FIG. 4). It is understood that the configuration of the acoustic telescope apparatus or system will dictate the type of cables to which the apparatus components may be attached.

Such an embodiment may employ the gravitational weight of the anchor and tension caused thereby between the anchor and buoyancy of the buoy. The weight of the anchor 39 and other non-buoyant or less buoyant components of the system will be pulled by gravity towards the sea floor, while the buoyancy of the buoy will counteract such gravitational forces, causing tension throughout the system and the cables and connectors between the components thereof. An acoustic release 28 may be situated in the array between the top of the main frame weldment 1 and the moveable tension member, preventing the motion of the tension member and securing the arms 13 in the stowed position. The mooring is preferably deployed with the array in the folded position.

In the depicted embodiment in FIGS. 5-10, the actuator rod 6 may be operationally configured to manipulate the pivot arm shafts 15 to move about the arm pivot brushing 16 at an angle (the arm pivot angle LH or RH, 17, 18). When the mooring deployment is complete and at the time the operators deem appropriate, a signal may be sent by the operator to activate the acoustic release 21, commanding array acoustic release 28 to release. When tension is applied, the actuator rod 6 moves downward (relative to the water column) guided by actuator guides. The force of the mooring tension will pull the moveable tension member (actuator rod) 6 down, in turn causing the head 2 of the actuator rod 6 to interact with linkage members (including the arm drive link 14 and arm drive shaft 15). This motion, in turn drives the pivot arm shaft to move, causing the arms 13 to expand outwards. In so doing, the actuator head will move downward whereby it will interact with arm pivot shaft, causing the arm pivot shaft to move downward. In turn, the arm pivot shaft may interact with the arm pivot link, which causes the arm member 13 to extend outwards and upwards about an angle between the arm member and the main weldment 1. The force of the mooring tension then holds the arms in the deployed position.

When the mission is complete or the operator deems it appropriate, the lower mooring acoustic release 21 is commanded to release. The tension in the mooring is relieved and the array arms are free to fold down under their own weight to their stowed position for recovery by the surface vessel.

In alternative embodiments, the array may incorporate active drive mechanisms to perform the same function—for instance in cases where the array is deployed via a structure other than a mooring and where mooring tension is not available to actuate the function. In alternative embodiments, the system may employ both active and passive (tension) means to deploy and close the arms.

In another embodiment, the acoustic telescope comprises six wide aperture (5 m) hydrophone arrays for electronically steering and focusing acoustic beams. These arrays can be individually mounted on a starfish shape apparatus, which can include five arms plus one vertical beam at the center and can stretch 10 meters across when fully extended. acoustic telescope system. In the extended position the hydrophone arrays can stretch about 10 meters across when fully extended, and can be situated in the water column, attached to a mooring near the edge of the continental shelf so that they can pick up sound from near and far across the ocean basin.

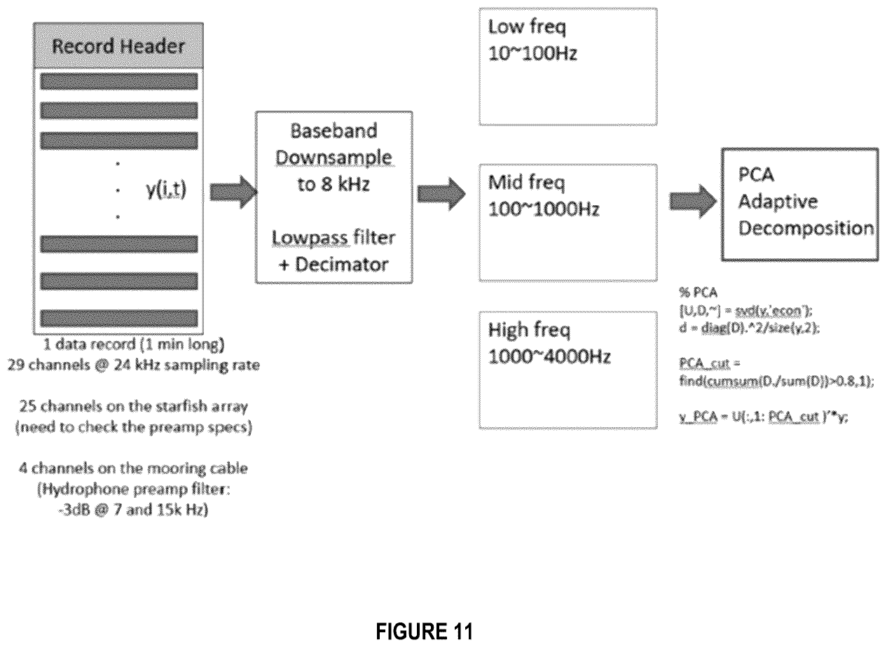

In this embodiment or other embodiment, the acoustic telescope system can include six phased hydrophone arrays capable of 3D acoustic beam steering and focusing to localize acoustic objects and is also equipped with a high-speed Wi-Fi system wirelessly connected to a nearby service buoy providing satellite communications for real-time high-volume data telemetry. The hydrophone arrays can be installed on a support structure of five rigid aluminum beams, as shown in FIGS. 1, 2, and 3. Each of the beams is 5 m long, giving a large aperture of 10 m, and the array uses an umbrella-like mechanism to open and close these array beams for deployment and recovery. The hydrophones on the acoustic telescope system can be positioned with unequal spacing. For example, the inner hydrophones can be closer to each other than the outer hydrophones, as shown in FIG. 11. This unequal spacing can provide unambiguous beamforming patterns for a broad frequency band from about 150 Hz to 4,000 Hz. The lower frequency limit can be due to the array aperture (10 m). The acoustic telescope system can include an acoustic vector sensor for low frequency high-resolution directivity (<150 Hz).

In one or more embodiments, hydrophones (for example, 40) may be dispersed throughout the acoustic telescope and may be located in or on one or more arm members 13, in or on the main weldment 1 below the attachment position of the arm members 13 to the main weldment 1, in or on the main weldment 1 above the attachment position of the arm members 13 to the main weldment 1, or a combination thereof.

In the embodiment depicted in FIGS. 1-9, the acoustic telescope comprises a plurality of arm members or arm assemblies 13a-e. Each arm member 13a-e comprises two ends, with one end which is connected to the main weldment 1 and an opposing end. The arm member comprises a length measured between the two ends. The arm member may be between 1-20 meters, 2-15 meters, 3-12 meters, 4-10 meters, and preferably between 4-8 meters. In the deployed state, each arm members may define a radius extending from the array. The arm members may be of similar or substantially equal size. In one or more embodiments, the arm members may define a radius of between 1-10 meters from the array. The arm members 13a-e may be equally spaces about the telescope or may be oblong. In an embodiment having an even number of arm members spaced event about the telescope, two opposing arm members may define a diameter. In such an embodiment, the wedge of the deployed array may be measured as distance between the two outermost ends of opposing arms. For example, in embodiments wherein an even number of propeller blades are used, the width of the array (i.e., the diameter) may span from the outer most tip of one arm member to the outermost tip of an opposing arm member. In one or more embodiments, the arm member length may be less than 1, 2, 3, 4, 5, 6, 7, 8, 9, or 10 meters. In a preferred embodiment, the arm may be less than 6 meters. In some embodiments, arm members of varying sizes may be used. The arm members may be spaced about the array in a spoke-shape.

When deployed, the arm member 13a-e rotates upward and outward creating an angle between the arm member and the main weldment 1 (or housing). The angle of rotation may be between 0 and 180 degrees, between 1 and 179 degrees, between 1 and 90 degrees, between 1 and 60 degrees, between 1 and 45 degrees, between 1 and 30 degrees, between 20-160 degrees, between 30-120 degrees, between 45-135 degrees, between 60-120 degrees, between 70-110 degrees, between 80-100 degrees, between 70-80 degrees, or substantially 90 degrees, between 30-89 degrees. In some embodiments, the arms may be set to deploy at differing angles than each other. Such may be performed via mechanical deployment or through modifications to the arm linkage elements to cause differentiating rotation. Likewise, the angle of movement may be manipulated by the user such as by mechanical means. In other embodiments, the configuration may be changed to cause the differing angle, such as by releasing the tension for only a short (or extended) period of time or otherwise modifying the movement of the actuator rod 6 (tension member).

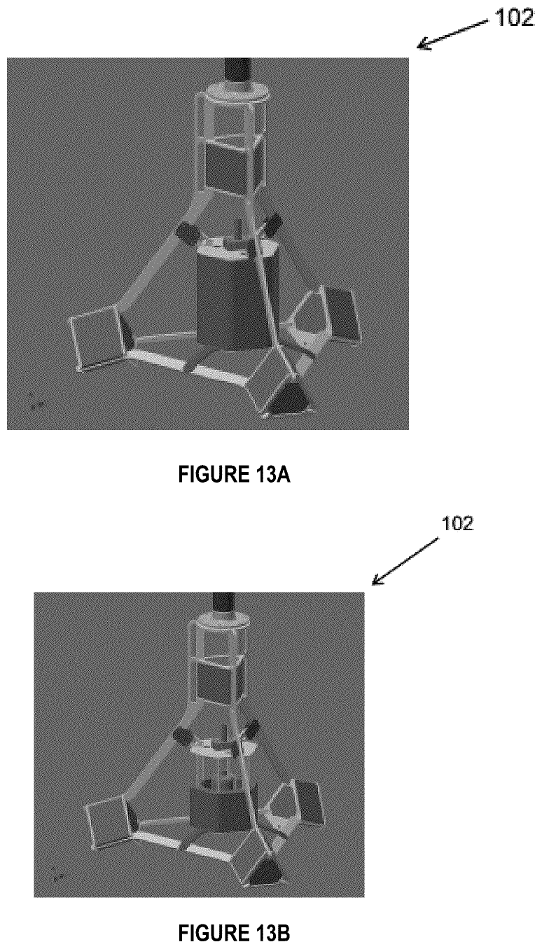

In alternative embodiments, the acoustic telescope may comprise a fixed apparatus such as the tetrahedral array set forth in FIGS. 12 and 13. FIG. 13 shows a representative main weldment for such an embodiment comprising a plurality of frame members which provide support for the internal mechanism and the hydrophones.

The acoustic telescope system can integrate multiple phased arrays for 3D acoustic beam steering and focusing with real-time high-volume data processing and telemetry. The acoustic telescope system can provide a more complete description of the environmental processes in the ocean by integrating oceanographic and meteorological measurements with underwater soundscape parameters, such as noise source position distributions, sound levels, spectral distributions, noise correlations, and higher-order statistics such as skewness (symmetry) and kurtosis (trends). The detected soundscape features can be used to monitor many biological, geophysical, and meteorological events, as well as oceanographic and anthropogenic processes and activities in the ocean.

The acoustic telescope system can be used to augment current single hydrophone acoustic listening stations and vastly increase the information gained by resolving each sound source's 3D position in the water-column rather than only detecting its presence. With the ability to localize and identify sound sources, the acoustic telescope system can extract such information as number and type of animals (acoustically) present, intensity and location of rainfall, wave height, seismic activity, ship traffic, and the like. The acoustic telescope system can provide remote acoustic sensing of oceanographic, meteorological, geological, and seismological processes and inference of marine life environments (soundscape ecology).

The 3D acoustic telescope system can be deployed and suspended in the middle of the water column at the edge of the shelf break for the best listening coverage into the deep ocean basin. The acoustic telescope apparats can allow for acoustic “fingerprinting,” recognizing features and defining parameters in the underwater soundscape environment. The shelf break currents are expected to be high, so the moorings can provide minimal mechanical vibration noise on the acoustic array.

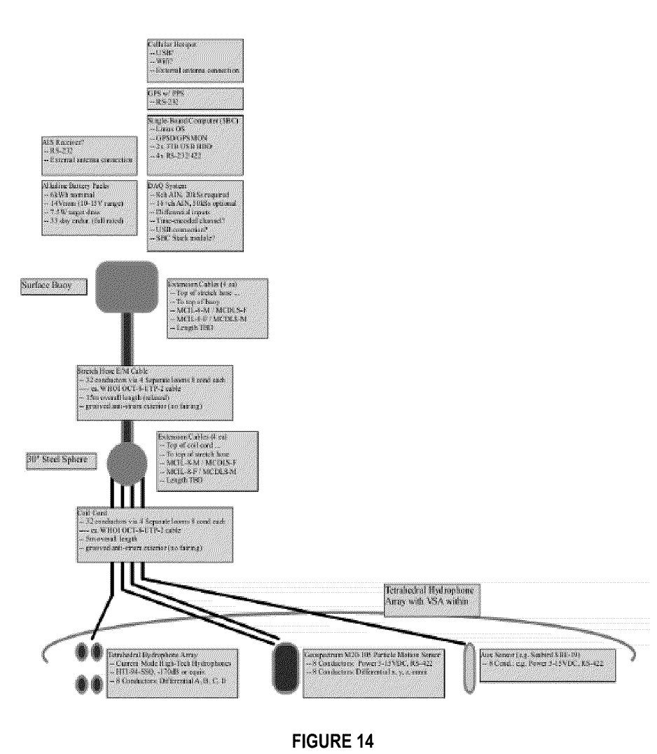

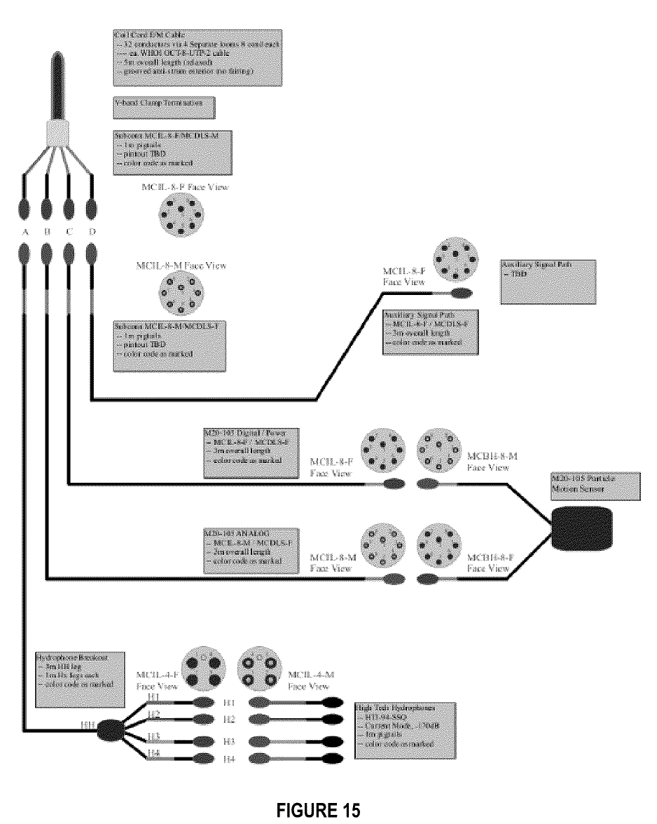

FIG. 14 presents a comprehensive list of different types of sound sources in the ocean, with example spectrograms showing different acoustic features, which can be used to distinguish sound sources. This list also shows very close connections between the underwater soundscape and many biological, geophysical, and meteorological processes, as well as anthropogenic activities. Notable examples of undersea sound sources shown in FIG. 14 include marine mammals and fish (biological), ice cracking, and glacier calving (polar geophysical), earthquake and submarine volcanic eruptions (seismology), rainfall and lightning (meteorological), ship, seismic exploration, sonar and industrial construction (anthropogenic). FIGS. 15 and 16 show that the undersea soundscape is tightly connected to important processes in the ocean. Hence, the acoustic telescope system can provide a comprehensive description of the ocean environmental processes by recognizing the acoustic features of different sources.

The acoustic telescope system can provide detection, recognition and identification are conducted to extract information from individual sound signals. The acoustic telescope system can also be used on a longer time scale to reveal long-term environmental variability. For example, the acoustic telescope system can be used to interpret seasonal changes of marine life habitats, such as baleen whale acoustic presence in the Southern Ocean, as seen in FIG. 20.

The acoustic telescope system can include passive acoustic monitoring (Helble et al., 2015). The acoustic telescope system can enable the imaging of diversified soundscape observations (basin scale ocean acoustic holography), inference of marine life environments and interactions (soundscape ecology), and remote acoustic sensing of oceanographic, geological, and seismological processes. The acoustic telescope system can describe sound source location distributions, spectrum levels, spectral power distributions, noise correlations, and higher-order statistics such as skewness (symmetry) and kurtosis (trends).

The passive acoustic monitoring can include three consecutive analysis steps: detection, classification, and localization (Helble et al., 2015). The acoustic telescope system can perform detection, classification, and localization by employing an acoustic back-propagation method (Lin et al., 2012; Newhall et al., 2012) across all channels of the acoustic telescope system. The detection and localization steps can be conducted simultaneously, for all signals, even concurrent ones. In addition, the back-propagation algorithm is capable of reconstructing source signatures, which can be used for signal classification. Classification of reconstructed source signatures can yield better results than using only received signals, as the signal distortion due to acoustic waveguide dispersion and multipath is restored. It can be described with sound source location distributions, spectrum levels, spectral power distributions, noise correlations, and higher-order statistics such as skewness (symmetry) and kurtosis (trends).

The method of using the acoustic telescope system can include deep learning and recurrent neural networks. The method of using the acoustic telescope system can include, but is not limited to: acoustic data and information processing for high-volume and high-speed data telemetry, acoustic feature recognition, and robust mooring engineering design and operations. The acoustic telescope system can include 32 channels (28 hydrophones and 1 acoustic vector sensor, which has 4 channels). The method of using the acoustic telescope system can include two sampling rates, 22.05 and 96 kHz. Five of the hydrophones can sample at 96 kHz for listening to array navigation signals and dolphin sounds, the rest can be sampled at 22.05 kHz, 24-bits. The real-time acoustic frequency band can include up to 4 kHz, because most of our sounds of interest for real-time analysis are below 4 kHz (see FIG. 4) and also the unambiguous beamforming pattern of our acoustic telescope stops at that frequency.

FIG. 14 shows the electronic system of the acoustic telescope system. The method of using the acoustic telescope system can include data rate of 32 channels sampled at 8 kHz with 24-bit resolution is 6,144 kbps. The 24-bit data can be saved in 16 bits, which can reduce the data rate to 4,096 kbps. It may be possible to use the OOI infrastructure by hopping the acoustic data to a satellite service mooring over a Wi-Fi link.

The method of using the acoustic telescope system comprises a data compression algorithm based on the principal component analysis that uses the eigenvectors of the cross-spectral density matrix to transform multi-channel acoustic data into the data correlation space, where the data information tends to contain in its subspace constituted by the first few higher order eigenvectors. The principal component analysis is also referred to the empirical orthogonal function decomposition. The cross-spectral density matrix can quantify the data coherence and the data information. By only keeping the transformation components of the higher order eigenvectors, most of the data information is retained. The method of using the acoustic telescope system can include data using the principal component analysis for an objective mapping of sound speed profile data collected. The method of using the acoustic telescope system can reduce the data rate as high as 80%. The method of using the acoustic telescope system can include taking up to 80% of the desired principal component analysis compression rate, which can reduce the data rate to 819.2 kbps. The method of using the acoustic telescope system can save all of the raw acoustic data (up to 96 kHz sampling rate) on the RAID installed in the acoustic telescope electronic system. Besides the principal component analysis compression, the method of using the acoustic telescope can implement baseband demodulation (Oppenheim and Schafer, 1975) to keep only the frequency bands that contain most of the data coherence. The compression rate from baseband demodulation can be one minus the ratio of the coherent bandwidth to the total real-time data bandwidth (4 kHz). The method of the acoustic telescope system can include data compression on the one third octave band, where the upper band-edge frequency is the lower band frequency times the cube root of two. The data compression can bring data rate down to 500 kbps.

The method of using the acoustic telescope system can use high-speed satellite internet services. For example, the method of using the acoustic telescope system can include using INMARSAT® FleetBroadband high-speed satellite internet services. FleetBroadband utilizes three geostationary satellites to provide almost worldwide broadband internet coverage. The associated cost to transmit large volumes of data on these satellites can be high, due to the cost of geostationary satellite launches and power requirements. Therefore, the method of using the acoustic telescope system can limit the data transmission rate in real-time to be less than 500 kbps on the satellite service. The method of using the acoustic telescope system can use adaptive data compression algorithm software to determine the compression rate according to available data bandwidth.

The method of using the acoustic telescope system can include acoustic feature recognition with a passive acoustic localization method, which can recover the signal distortion after traveling through the ocean environment. The source signal recovering can increase the performance of acoustic feature recognition and classification. The method of using the acoustic telescope system can include acoustics signal back-propagation method, which can localize sound sources and reconstruct source signatures. This method can use a physics-based signal processing technique, utilizing the propagation properties of sound in an ocean waveguide. Acoustic theory shows that low frequency sound propagation has significant acoustic waveguide dispersion (e.g., Frisk, 1994), and high frequency sound with a broad bandwidth can have multipath dispersion. Consequently, the method of using the acoustic telescope system can include a sampled acoustic pulse received on the hydrophone with separate arrival times. These arrival time differences can provide useful information on the source-to-receiver distance. The signal that is simultaneously received on the multi-channel horizontal array of hydrophones can provide accurate source direction (azimuth) for initializing the back propagation technique. The method of using the acoustic telescope system can include Gauss-Markov inverse theory employed to derive an adaptive back-propagator that is capable of restoring either the waveguide or multipath dispersion to recover the original source signature, and also capable of separating signals from noisy data so the backpropagation will not have significant influence from the noise. After localizing sound sources, classification of the reconstructed source signatures can be implemented using state-of-the-art deep learning techniques. The method of using the acoustic telescope system can include long short-term memory and recurrent neural networks to classify repeatedly occurring similar source signatures, allowing tracking of similar sources (e.g. upcalls).

The long baseline navigation system can be used to determine the accurate positions of hydrophones. The long baseline navigation system can include one or more acoustic beacons (usually three) deployed on the seafloor in a simple polygon formation within about 200-300 meters from the mooring anchor position. The beacon locations can be surveyed accurately from a ship. In operation, the beacons can consequently transmit positioning signals. The signals can be record and time stamp by the data acquisition system. The position of each hydrophone can be calculated in real-time by the mooring controller using time difference of arrival.

The single board computers can be installed in the mooring of the acoustic telescope system. In an embodiment, one single board computers can provide normal computing operations, such as scheduling, data collection, and data telemetry, and another single board computer can provide more intensive onboard processing for the data compression.

In an embodiment, the acoustic telescope system can have three central processing units on the mooring: one in the surface buoy well for controlling power and telemetry, one in the Noisy electronics housing for controlling data collection and remote control (see FIG. 12), and one in the Quiet electronics housing to interface with the Chip-Scale Atomic Clock (CSAC) and the Noisy housing and to provide control of the Quiet electronics components. The software system installed on the SBC's can include a remote-control software. The remote-control software can include software used on PI Zitterbart's Antarctic coastal observatory (Richter et al., 2018). The remote-control software can allow users to remotely adjust all of the telescope operation parameters, including data compression and transmission protocols.

The electrical power architecture of the acoustic telescope system can be divided into two separate functional blocks, each with separate requirements. The subsea data acquisition electronics require power free from electrical noise and has relatively low power consumption in comparison to the surface section. The surface controller section can use higher power for computation, telemetry, and data storage. The surface controller section can be more resilient to electrical noise than the subsea data acquisition electronics. In an embodiment, the configuration can simplify the mooring design in that power does not need to be transmitted from the surface and can create an electrically quiet section for noise sensitive measurements that are isolated from the higher power controller, data storage, and telemetry section.

The method of using the acoustic telescope system can include using the acoustic telescope system as remote acoustic sampling super-nodes. The acoustic telescope apparatus can be deployed and individually linked to the internet to serve as hubs for connections with nearby undersea platforms. The method can provide a large volume of ocean scientific data can be transmitted in real-time through these super-nodes. To extend the acoustic telescope system' design to become such a super node, its design and data processing capabilities can be flexible and allow the attachment of more sensors. For example, the acoustic telescope system can be coupled to an ocean bottom seismometer with the acoustic telescope, extending the monitoring capabilities to seismic frequencies and providing real-time offshore information for earthquake surveillance. This can enable cost effective deployments of real-time earthquake monitoring.

The method of using the acoustic telescope system can include using multi-telescope deployments to provide a spatially resolved map of all acoustic sources in a large area. The method can provide less frequent mooring services and archival data retrieval using surface vessels or other platforms, along with affordable satellite communication in the future, reducing cost for high-resolution passive acoustic sensing of ocean environments using this real-time data telemetry 3D acoustics technology.

One of ordinary skill in the art will readily appreciate that alternate but functionally equivalent components, materials, designs, and equipment can be used. The inclusion of additional elements can be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention. Furthermore, all patents, test procedures, and other documents cited in this application are fully incorporated by reference to the extent such disclosure is not inconsistent with this application.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits can be the values from the examples. Certain lower limits, upper limits and ranges appear in at least one claims below. All numerical values are “about” or “approximately” the indicated value, and consider experimental error and variations that would be expected by a person having ordinary skill in the art.

Although the invention has been described with reference to the above examples, it will be understood that modifications and variations are encompassed within the spirit and scope of the invention. Accordingly, the invention is limited only by the following claims.

### REFERENCES

1. Baumgartner, Mark F., David M. Fratantoni, Thomas P. Hurst, Moira W. Brown, John H. Prescott, Tim V. N. Cole, Sofie M. Van Parijs, and Mark Johnson. “Real-Time Reporting of Baleen Whale Passive Acoustic Detections from Ocean Gliders.” Journal of the Acoustical Society of America, vol. 134, no. 3, 2013, pp. 1814-23, doi: 10.1121/1.4816406.
2. Bazile Kinda, G., and Julien Bonnel. “Passive Acoustic Observations of Tide Height in the Iroise Sea Using Ambient Noise.” The Journal of the Acoustical Society of America, vol. 138, no. 3, Acoustical Society of America, Sep. 2015, p. EL 299-EL304, doi: 10.1121/1.4929740.
3. Booth, C. G., C. S. Oedekoven, D. Gillespie, J. Macaulay, R. Plunkett, R. Joy, D. Harris, J. Wood, T. A. Marques, L. Marshall, U. K. Verfuss, P. Tyack, M. Johnson, and L. Thomas. Assessing the Viability of Density Estimation for Cetaceans from Passive Acoustic Fixed Sensors throughout the Life Cycle of an Offshore E&P Field Development. Report Number: SMRUC-OGP-2017-001. 2017.
4. Bradley, David L., and Richard Stern. Underwater Sound and the Marine Mammal Acoustic Environment. 2008.
5. Brodkin, Jon. With Latency as Low as 25 ms, SpaceX to Launch Broadband Satellites in 2019|Ars Technica. 2017, p. 1, https://arstechnica.com/information-technology/2017/05/spacexs falcon-9-rocket-will-launch-thousands-of-broadband-satellites/.
6. Brodkin, Jon. Low-Latency Satellite Broadband Gets Approval to Serve US Residents |Ars Technica. 2017, https://arstechnica.com/information-technology/2017/06/low-latency satellite-broadband-gets-approval-to-serve-us-residents/.
7. Collins, Melanie Jane. Passive Acoustic Monitoring of Weather Patterns in the Ocean 2011.
8. Council, National Research. Marine Mammal Populations and Ocean Noise. National Academies Press, 2005, doi: 10.17226/11147.
9. Dähne, Michael, Anita Gilles, Klaus Lucke, Verena Peschko, Sven Adler, Kathrin Krügel, Janne Sundermeyer, and Ursula Siebert. “Effects of Pile-Driving on Harbour Porpoises (Phocoena Phocoena) at the First Offshore Wind Farm in Germany.” Environmental Research Letters, vol. 8, no. 2, IOP Publishing, Jun. 2013, p. 25002, doi: 10.1088/1748-9326/8/2/025002.
10. Davis, Genevieve E. . . . Sofie M. Van Parijs. “Long-Term Passive Acoustic Recordings Track the Changing Distribution of North Atlantic Right Whales (Eubalaena Glacialis) from 2004 to 2014.” Scientific Reports, vol. 7, no. 1, Nature Publishing Group, Dec. 2017, p. 13460, doi: 10.1038/s41598-017-13359-3.
11. Dziak, R. P., D. R. Bohnenstiehl, E. T. Baker, H. Matsumoto, J. Caplan-Auerbach, R. W. Embley, S. G. Merle, S. L. Walker, T. K. Lau, and W. W. Chadwick. “Long-Term Explosive Degassing and Debris Flow Activity at West Mata Submarine Volcano.” Geophysical Research Letters, vol. 42, no. 5, Mar. 2015, pp. 1480-87, doi: 10.1002/2014GL 062603.
12. Fernández, Santiago, Alex Graves, and Jürgen Schmidhuber. “Sequence Labelling in Structured Domains with Hierarchical Recurrent Neural Networks.” IN PROC. 20TH INT. JOINT CONF. ON ARTIFICIAL INTELLIGENCE, IJCAI 2007, 2007, pp. 774-779.
13. Frisk, Geroge V. Ocean and Seabed Acoustics. Pearson Education, 1994.
14. Gawarkiewicz, Glen, Robert Todd, Weifeng Zhang, Jacob Partida, Avijit Gangopadhyay, Mahmud-Ul-Hasan Monim, Paula Fratantoni, Anna Malek Mercer, and Margaret Dent. “The Changing Nature of Shelf-Break Exchange Revealed by the OOI Pioneer Array.” Oceanography, vol. 31, no. 1, Mar. 2018, pp. 60-70, doi: 10.5670/oceanog.2018.110.
15. Gervaise, Cédric, Yvan Simard, Nathalie Roy, Bazile Kinda, and Nadia Ménard. “Shipping Noise in Whale Habitat: Characteristics, Sources, Budget, and Impact on Belugas in Saguenay—St. Lawrence Marine Park Hub.” The Journal of the Acoustical Society of America, vol. 132, no. 1, Acoustical Society of America, Jul. 2012, pp. 76-89, doi: 10.1121/1.4728190.
16. Glowacki, O., G. B. Deane, M. Moskalik, Ph. Blondel, J. Tegowski, and M. Blaszczyk. “Underwater Acoustic Signatures of Glacier Calving.” Geophysical Research Letters, vol. 42, no. 3, Feb. 2015, pp. 804-12, doi:10.1002/2014GL062859.
17. Halvorsen, Michele B., Brandon M. Casper, Frazer Matthews, Thomas J. Carlson, and Arthur N. Popper. “Effects of Exposure to Pile-Driving Sounds on the Lake Sturgeon, Nile Tilapia and Hogchoker.” Proceedings. Biological Sciences, vol. 279, no. 1748, The Royal Society, Dec. 2012, pp. 4705-14, doi:10.1098/rspb.2012.1544.
18. Halvorsen, Michele B., David G. Zeddies, William T. Ellison, David R. Chicoine, and Arthur N. Popper. “Effects of Mid-Frequency Active Sonar on Hearing in Fish.” The Journal of the Acoustical Society of America, vol. 131, no. 1, Acoustical Society of America, Jan. 2012, pp. 599-607, doi:10.1121/1.3664082.
19. Haver, Samara M, Holger Klinck. “Monitoring Long-Term Soundscape Trends in U.S. Waters: The NOAA/NPS Ocean Noise Reference Station Network.” Marine Policy, vol. 90, Apr. 2018, pp. 6-13, doi:10.1016/j.marpol.2018.01.023.
20. Haver, Samara M., Holger Klinck, Sharon L. Nieukirk, Haru Matsumoto, Robert P. Dziak, and Jennifer L. Miksis-Olds. “The Not-so-Silent World: Measuring Arctic, Equatorial, and Antarctic Soundscapes in the Atlantic Ocean.” Deep Sea Research Part I: Oceanographic Research Papers, vol. 122, Pergamon, Apr. 2017, pp. 95-104, doi:10.1016/J.DSR.2017.03.002.
21. Heenehan, Heather L., Sofie M. Van Parijs, Lars Bejder, Julian A. Tyne, and David W. Johnston. “Using Acoustics to Prioritize Management Decisions to Protect Coastal Dolphins: A Case Study Using Hawaiian Spinner Dolphins.” Marine Policy, vol. 75, Pergamon, Jan. 2017, pp. 84-90, doi:10.1016/J.MARPOL.2016.10.015.
22. Helble, Tyler A., Glenn R. Ierley, Gerald L. D'Spain, and Stephen W. Martin. “Automated Acoustic Localization and Call Association for Vocalizing Humpback Whales on the Navy's Pacific Missile Range Facility.” The Journal of the Acoustical Society of America, vol. 137, no. 1, Acoustical Society of America, Jan. 2015, pp. 11-21, doi:10.1121/1.4904505.
23. Hochreiter, Sepp, and Jürgen Schmidhuber. “Long Short-Term Memory.” Neural Computation, vol. 9, no. 8, MIT Press 238 Main St., Suite 500, Cambridge, MA 02142-1046 USA journals-info@mit.edu, Nov. 1997, pp. 1735-80, doi: 10.1162/neco.1997.9.8.1735.
24. Huang, Xuedong. Microsoft Researchers Achieve New Conversational Speech Recognition Milestone—Microsoft Research. 2017, https://www.microsoft.com/en us/research/blog/microsoft-researchers-achieve-new-conversational-speech-recognition milestone/.
25. Jolliffe, I. T. Principal Component Analysis. 2nd ed., Springer-Verlag, 2002, doi:10.1007/b98835.
26. Kaplan, Maxwell B., T. Aran Mooney, and Jim Partan. “Spatiotemporal Variability in Coral Reef Soundscapes in St. John, U.S. Virgin Islands.” The Journal of the Acoustical Society of America, vol. 134, no. 5, Acoustical Society of America, Nov. 2013, pp. 4177-4177, doi:10.1121/1.4831313.
27. Küsel, Elizabeth T., David K. Mellinger, Len Thomas, Tiago A. Marques, David Moretti, and Jessica Ward. “Cetacean Population Density Estimation from Single Fixed Sensors Using Passive Acoustics.” The Journal of the Acoustical Society of America, vol. 129, no. 6, Jun. 2011, pp. 3610-22, doi:10.1121/1.3583504.
28. LeCun, Yann, Yoshua Bengio, and Geoffrey Hinton. “Deep Learning.” Nature, vol. 521, no. 7553, Nature Publishing Group, May 2015, pp. 436-44, doi:10.1038/nature14539.
29. Lin, Ying-Tsong, Arthur E. Newhall, Timothy F. Duda, Pierre F. J. Lermusiaux, and Patrick J. Haley. “Merging Multiple-Partial-Depth Data Time Series Using Objective Empirical Orthogonal Function Fitting.” IEEE Journal of Oceanic Engineering, vol. 35, no. 4, Oct. 2010, pp. 710-21, doi:10.1109/JOE.2010.2052875.
30. Lin, Ying-Tsong, Arthur E. Newhall, and James F. Lynch. “Low-Frequency Broadband Sound Source Localization Using an Adaptive Normal Mode Back-Propagation Approach in a Shallow-Water Ocean.” The Journal of the Acoustical Society of America, vol. 131, no. 2, Feb. 2012, pp. 1798-813, doi:10.1121/1.3672643.
31. Marques, Tiago A., Len Thomas, Stephen W. Martin, David K. Mellinger, Jessica A. Ward, David J. Moretti, Danielle Harris, and Peter L. Tyack. “Estimating Animal Population Density Using Passive Acoustics.” Biological Reviews, vol. 88, no. 2, May 2013, pp. 287-309, doi:10.1111/brv.12001.
32. Martin, Stephen W., Tiago A. Marques, Len Thomas, Ronald P. Morrissey, Susan Jarvis, Nancy DiMarzio, David Moretti, and David K. Mellinger. “Estimating Minke Whale (Balaenoptera Acutorostrata) Boing Sound Density Using Passive Acoustic Sensors.” Marine Mammal Science, vol. 29, no. 1, Blackwell Publishing Inc, Jan. 2013, pp. 142-58, doi:10.1111/j.1748-7692.2011.00561.x.
33. Matsumoto, Haru, Joseph H. Haxel, Robert P. Dziak, Delwayne R. Bohnenstiehl, and Robert W. Embley. “Mapping the Sound Field of an Erupting Submarine Volcano Using an Acoustic Glider.” The Journal of the Acoustical Society of America, vol. 129, no. 3, Acoustical Society of America, Mar. 2011, p. EL 94-EL99, doi:10.1121/1.3547720.
34. Menze, Sebastian, Daniel P. Zitterbart, Ilse van Opzeeland, and Olaf Boebel. “The Influence of Sea Ice, Wind Speed and Marine Mammals on Southern Ocean Ambient Sound.” Royal Society Open Science, vol. 4, no. 1, The Royal Society, Jan. 2017, p. 160370, doi:10.1098/rsos.160370.
35. Merrill, Jennifer. “Human-Generated Ocean Sound and the Effects on Marine Life.” Marine Technology Society Journal, vol. 37, no. 4, Dec. 2003, pp. 4-5, doi:10.4031/002533203787537005.
36. Mooney, T. Aran, Ashlee Lillis, Maxwell B. Kaplan, Justin Suca, and Marc Lammers. “Variability in Coral Reef Soundscapes, Spatiotemporal Differences, Biophysical and Behavioral Drivers, and Associations with Local Biota.” The Journal of the Acoustical Society of America, vol. 141, no. 5, Acoustical Society of America, May 2017, pp. 3939-3939, doi:10.1121/1.4988920.
37. Müller, Christian, Vera Schlindwein, Alfons Eckstaller, and Heinrich Miller. “Singing Icebergs.” Science, vol. 310, 2005, doi:10.1126/science.1117145.
38. Newhall, A. E., T. F. Duda, K. v. d. Heydt, J. D. Irish, J. N. Kemp, S. A. Lerner, S. P. Liberatore, Y. T. Lin, J. F. Lynch, A. R. Maffei, A. K. Morozov, A. Shmelev, C. J. Sellers, W. E. Witzell, and Jr. Acoustic and Oceanographic Observations and Configuration for the WHOI Moorings from the SW06Experiment. 2007.
39. Newhall, Arthur E., Ying-Tsong Lin, James F. Lynch, Mark F. Baumgartner, and Glen G. Gawarkiewicz. “Long Distance Passive Localization of Vocalizing Sei Whales Using an Acoustic Normal Mode Approach.” The Journal of the Acoustical Society of America, vol. 131, no. 2, Feb. 2012, pp. 1814-25, doi:10.1121/1.3666015.
40. Northrop, John. “Evidence of Dispersion in Earthquake T Phases.” Journal of Geophysical Research, vol. 67, no. 7, Jul. 1962, pp. 2823-30, doi:10.1029/JZ067i007p02823.
41. Nowacek, Douglas P., Lesley H. Thorne, David W. Johnston, and P. Tyack. “Responses of Cetaceans to Anthropogenic Noise.” Mammal Review, vol. 37, no. 2, Blackwell Publishing Ltd, Apr. 2007, pp. 81-115, doi:10.1111/j.1365-2907.2007.00104.x.
42. Oppenheim, A. V., and R. W. Schafer. Digital Signal Processing. Prentice Hall Inc., Englewood Cliffe, 1975, doi:10.1002/piuz.19760070412.
43. Resing, Joseph A. Hans Thomas. “Active Submarine Eruption of Boninite in the Northeastern Lau Basin.” Nature Geoscience, vol. 4, no. 11, Nature Publishing Group, Nov. 2011, pp. 799-806, doi:10.1038/ngeo1275.
44. Richter, Sebastian, Richard C. Gerum, Werner Schneider, Ben Fabry, Céline Le Bohec, and Daniel P. Zitterbart. “A Remote-Controlled Observatory for Behavioural and Ecological Research: A Case Study on Emperor Penguins.” Methods in Ecology and Evolution, Feb. 2018, doi:10.1111/2041-210X.12971.
45. Rubin, K. H., S. A. Soule, W. W. Chadwick Jr., D. J. Fornari, D. A. Clague, and R. W. Embley. “Volcanic Eruptions in the Deep Sea.” Oceanography, vol. 25, no. 1, 2012, pp. 142-57, doi:10.5670/oceanog.2011.65.
46. Salehinejad, Hojjat, Julianne Baarbe, Sharan Sankar, Joseph Barfett, Errol Colak, and Shahrokh Valaee. Recent Advances in Recurrent Neural Networks. Dec. 2017.
47. Scheidat, Meike, Jakob Tougaard, Sophie Brasseur, Jacob Carstensen, Tamara van Polanen Petel, Jonas Teilmann, and Peter Reijnders. “Harbour Porpoises (Phocoena Phocoena) and Wind Farms: A Case Study in the Dutch North Sea.” Environmental Research Letters, vol. 6, no. 2, IOP Publishing, Apr. 2011, p. 25102, doi:10.1088/1748-9326/6/2/025102.
48. Snodgrass, James M., and Adrian F. Richards. “Observations of Underwater Volcanic Acoustics at Bárcena Volcano, San Benedicto Island, Mexico, and in Shelikof Strait, Alaska.” Transactions, American Geophysical Union, vol. 37, no. 1, Feb. 1956, p. 97, doi:10.1029/TR037i001p00097.
49. Thode, Aaron, Delphine Mathias, Janice Straley, Victoria O'Connell, Linda Behnken, Dan Falvey, Lauren Wild, John Calambokidis, Gregory Schorr, Russell Andrews, Joseph Liddle, and Phillip Lestenkof. “Cues, Creaks, and Decoys: Using Passive Acoustic Monitoring as a Tool for Studying Sperm Whale Depredation.” ICES Journal of Marine Science, vol. 72, no. 5, Oxford University Press, Jun. 2015, pp. 1621-36, doi:10.1093/icesjms/fsv024.
50. Tougaard, Jakob. “Underwater Noise from a Wave Energy Converter Is Unlikely to Affect Marine Mammals.” PLOS ONE, edited by Gianni Pavan, vol. 10, no. 7, Public Library of Science, Jul. 2015, p. e0132391, doi:10.1371/journal.pone.0132391.
51. Urazghildiiev, Ildar R., and Sofie M. Van Parijs. “Automatic Grunt Detector and Recognizer for Atlantic Cod (Gadus Morhua) .” The Journal of the Acoustical Society of America, vol. 139, no. 5, Acoustical Society of America, May 2016, pp. 2532-40, doi:10.1121/1.4948569.
52. Van Parijs, SM, CW Clark, RS Sousa-Lima, SE Parks, S. Rankin, D. Risch, and IC Van Opzeeland. “Management and Research Applications of Real-Time and Archival Passive Acoustic Sensors over Varying Temporal and Spatial Scales.” Marine Ecology Progress Series, vol. 395, Dec. 2009, pp. 21-36, doi:10.3354/meps08123.
53. Versluis, Michel, Anna von der Heydt, Detlef Lohse, and Barbara Schmitz. “On the Sound of Snapping Shrimp: The Collapse of a Cavitation Bubble.” The Journal of the Acoustical Society of America, vol. 108, no. 5, Acoustical Society of America, Nov. 2000, pp. 2541-42, doi:10.1121/1.4743418.
54. Vester, Heike I., Lars P. Folkow, and A. S. Blix. “Click Sounds Produced by Cod (Gadus Morhua) .” The Journal of the Acoustical Society of America, vol. 115, no. 2, Acoustical Society of America, Feb 2004, pp. 914-19, doi:10.1121/1.1639106.
55. Wenz, Gordon M. “Acoustic Ambient Noise in the Ocean: Spectra and Sources.” The Journal of the Acoustical Society of America, vol. 34, no. 12, Acoustical Society of America, Dec. 1962, pp. 1936-56, doi:10.1121/1.1909155.
56. Wyler, Greg. OneWeb|OneWorld. 2017, http://www.oneweb.world/#technology.

What is claimed is:

1. An acoustic telescope system for surveying the ocean, said ocean comprising an ocean floor, comprising:
a. a hydrophone array comprising a plurality of hydrophones and connected in line to at least one surface buoy and an anchor, wherein said anchor contacts said ocean floor when the system is in use and said at least one surface buoy is opposite said anchor;
b. at least one release connected in line with said hydrophone array in between said hydrophone array and said anchor; and
c. at least one power source.

2. The acoustic telescope system of claim 1 wherein said hydrophone array comprises a main weldment and at least one arm assembly, wherein said hydrophones are located along said at least one arm assembly.

3. The acoustic telescope of claim 2 wherein said hydrophone array comprises five arm assemblies, each arm assembly having at least one hydrophone located along the length of said arm assembly.

4. The acoustic telescope system of claim 1, wherein said hydrophones are movable to focus sound waves.

5. The acoustic telescope system of claim 1, wherein said hydrophone array comprises at least two configurations, wherein the configurations are collapsed and extended.

6. The acoustic telescope system of claim 1, wherein said hydrophone array has a diameter of about 10 meters.

7. The acoustic telescope system of claim 1 wherein said hydrophone array comprises:
a. a main weldment and a plurality of elongated arm assemblies each arm assembly
having a proximal end at said main weldment and a distal end;
b. a plurality of hydrophones located along each said arm assembly;
c. a release that acts on said plurality of elongated arm assemblies to move said arm assemblies between an open and closed configuration; and
d. a top cable interface that removably connects said telescope to at least one buoy; and
e. a lower cable interface that removably connects said telescope to at least one anchor.

8. An acoustic telescope comprising:
a. a main weldment and a plurality of elongated arm assemblies each arm assembly
having a proximal end at said main weldment and a distal end; wherein each arm assembly is comprises a pivot arm shaft and pivot arm brushing;
b. a plurality of hydrophones located along each said arm assembly;
c. a telescope release comprising an actuator rod operationally configured to manipulate said pivot arm shafts to move about said pivot arm brushing at an angle;
d. a top cable interface and a bottom cable interface that removably connect said telescope to a mooring line; wherein said mooring line comprises at least one buoy, at least one anchor;
wherein when said actuator rod is activated, the force of said mooring line creates tension to pull said actuator toward said at least one anchor such that said pivot arm shafts cause said arm assemblies to expand outward from some proximal end and about an angle between said arm assemblies and said main weldment such that said force of said mooring line causes the arm assemblies to remain in said angle until said actuator rod is released.

9. The acoustic telescope of claim 8 wherein said release comprises a drive mechanism.

10. The acoustic telescope of claim 8 wherein said mooring line further comprises at least one selected from the group consisting of: a subsurface float, hose interface buoy, a power cube, a deepwater syntactic sphere, a long baseline transducer and cage, a mooring chain release.

11. The acoustic telescope of claim 8 wherein said inner hydrophones located near the distal end of each of said arm assemblies are closer to each other than said hydrophones located near the proximal end of each of said arm assemblies.

12. An acoustic telescope system method comprising:
a. recognizing with a passive acoustic localization, wherein the passive acoustic localization recovers a signal distortion after traveling through the ocean environment;
b. sampling acoustic pulses received on a hydrophone with separate arrival times; and
c. localizing sound sources with acoustics signal back-propagation to reconstruct a source signature.

13. The method of an acoustic telescope system method of claim 12, wherein a Gauss-Markov inverse theory derives the signal back-propagation capable of restoring a waveguide or a multipath dispersion to recover the source signature.

14. The method of an acoustic telescope system method of claim 12, wherein the method further comprises: classifying a reconstructed source signatures using deep learning, wherein the deep learning uses long short-term memory and recurrent neural networks to classify repeatedly occurring similar source signatures.
